(19) United States
(12) Patent Application Publication
(10) Pub. No.: US 2020/0334703 A1
(43) Pub. Date: Oct. 22, 2020

(54) SYSTEM AND METHOD FOR PROVIDING IN-FLIGHT REWARDS

(71) Applicant: Panasonic Avionics Corporation, Lake Forest, CA (US)

(72) Inventor: Wayne Chang, Placentia, CA (US)

(21) Appl. No.: 16/390,251

(22) Filed: Apr. 22, 2019

(51) Int. Cl. G06Q 30/02

(52) U.S. Cl. CPC G06Q 30/0227; G06Q 30/0224; G06Q 30/0233; G06Q 30/0208

(57) ABSTRACT

System, methods, and computer-readable media for providing in-flight rewards are provided. The method can include receiving information related to a plurality of rewards for redemption by a user, wherein each reward is associated with completion criteria including one or more actions required to redeem the reward. The method can further include combining the completion criteria with the rewards as offers and presenting one or more offers via a display device based on the user activity and one or more flight details. The method can include detecting satisfaction of the completion criteria and presenting the one or more rewards via the display device based on the detecting.

### BACKGROUND

### Technical Field

This disclosure relates to in-flight entertainment (IFE) systems. More specifically, this disclosure relates to passenger rewards and various tangible benefits provided in return for certain interactions with IFE systems aboard, for example, an airline flight.

### Related Art

Studies show that passenger satisfaction towards air travel experience has gradually declined in recent years. One of the main causes of customer dissatisfaction is increased airfare and/or crowded passenger cabins. Fares for airline travel have been on the rise due to commercial carriers' continuous efforts to develop additional ways to increase revenue; passengers are, of course, the main source of that revenue, and the fuller the cabin, the greater the revenue per flight. It would be advantageous to incentivize passengers to interact with IFE systems and increase satisfaction with their commercial air experience.

### SUMMARY

An aspect of the disclosure relates to a method for providing in-flight rewards. The method can include receiving, at one or more processors, information related to a plurality of rewards for redemption by a user, each reward of the plurality of rewards being associated with completion criteria, the completion criteria including one or more actions required to redeem each reward. The method can include combining, at the one or more processors, the completion criteria with one or more rewards of the plurality of rewards as offers. The method can include detecting user activity at a display device. The method can include presenting, by the one or more processors, one or more offers of a plurality of offers via the display device based on the user activity and one or more flight details. The method can include detecting, at the one or more processors, satisfaction of the completion criteria. The method can include presenting the one or more rewards via the display device based on the detecting.

The method can further include delivering the one or more rewards to an online account of the user, wherein the one or more rewards comprises at least one of a coupon, a discount, and a gift certificate. The method can further include storing a user profile for the user, the user profile including reward redemption history, personal information, and personal preferences of the user. The method can further include storing a distributed rewards ledger in memory, including the reward, completion criteria, and identification of the user. The presenting can be further based on the user profile. The completion criteria can includes one of consuming a specified type of media and completing a survey. The reward can be transmitted in a message to an electronic account of the user, wherein the message comprises one of an email, a text message, and a voucher stored in an electronic wallet. The one or more flight details can include one or more of a takeoff and landing time, a takeoff and landing destination, duration of flight, and a time during flight.

Another aspect of the disclosure relates to a system for providing in-flight rewards. The system can have a memory configured to store information related to a plurality of rewards for redemption by a user, each reward of the plurality of rewards being associated with completion criteria, the completion criteria including one or more actions required to redeem each reward. The system can have one or more processors. The one or more processors can combine, at the one or more processors, the completion criteria with one or more rewards of the plurality of rewards as offers. The one or more processors can detect user activity at a display device. The one or more processors can present, by the one or more processors, one or more offers of a plurality of offers via the display device based on the user activity and one or more flight details. The one or more processors can detect, at the one or more processors, satisfaction of the completion criteria. The one or more processors can present the one or more rewards via the display device based on the detecting.

Another aspect of the disclosure relates to a non-transitory computer-readable medium storing instructions for providing in-flight rewards. When executed by one or more processors, the instruction cause the one or more processors to receive information related to a plurality of rewards for redemption by a user. Each reward of the plurality of rewards can be associated with completion criteria. The completion criteria can include one or more actions required to redeem each reward. The instructions can further cause the processor to combine the completion criteria with one or more rewards of the plurality of rewards as offers. The instructions can further cause the processor to detect user activity at a display device. The instructions can further cause the processor to present one or more offers of a plurality of offers via the display device based on the user activity and one or more flight details. The instructions can further cause the processor to detect satisfaction of the completion criteria. The instructions can further cause the processor to present the one or more rewards via the display device based on the detecting.

Other advantages and benefits of the disclosed system and methods will be apparent to one or ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a graphical representation of a system for providing in-flight rewards;

FIG. 2 is functional block diagram of a device for performing the functions of the method of FIG. 1; and

FIG. 3 is a flowchart of an embodiment of a method for providing in-flight rewards associated with the system of FIG. 1 and the device of FIG. 2.

### DETAILED DESCRIPTION

The disclosed systems and methods aim to provide passengers with tangible rewards based on the completion of various activities within the IFE system. For example, a passenger can interact with the IFE system to perform certain tasks, such as taking a survey, reading a book, or watching a movie. Once that activity is completed or associated completion criteria associated with the task are complete, the user (e.g., passenger) can be presented with certain tangible rewards. In some examples, the tangible rewards can be products, subscriptions to content and/or connectivity, coupons, gift certificates, or discounts to stores, food or drink products aboard the flight, among other options.

Reference throughout this specification to “one embodiment” or “an embodiment” or an “implementation” means that a particular feature, structure, or characteristic described in connection with the embodiment is included in at least one embodiment or implementation. Thus, appearances of the phrases “in one embodiment” or “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations

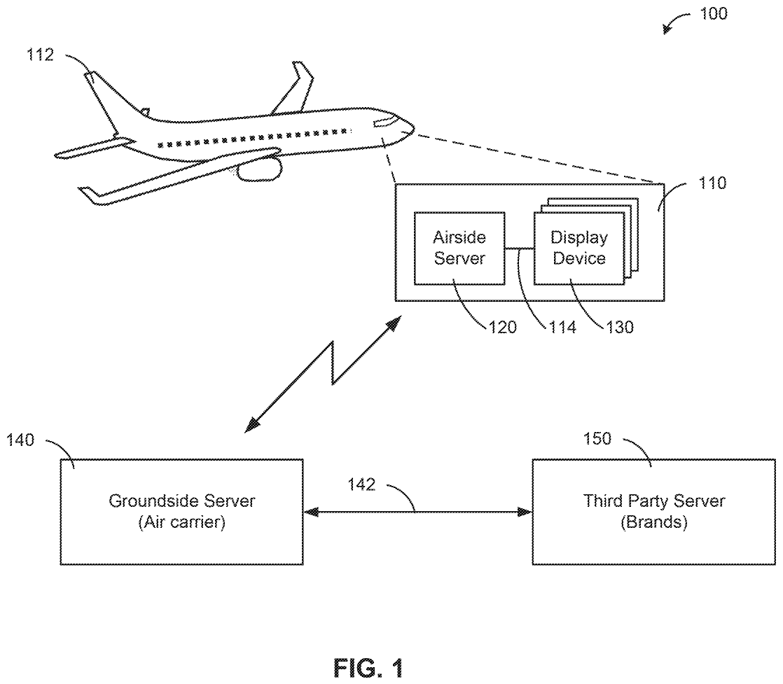

FIG. 1 is a graphical representation of a system for providing in-flight rewards. A system for providing in-flight rewards (system) 100 can have an airside server 120. The airside server 120 can be communicatively coupled to a plurality of display devices 130. Only one display device 130 is labeled, but it represents the plurality of display devices 130 onboard an airplane 112 or other multi-passenger transport vehicle. As such the following description may refer to a single display device 130 or a plurality of display devices 130.

The display device 130 can be a seatback monitor installed in the seatback of each passenger seat on the airplane 112 operated by an air carrier, for example. The display devices 130 may also be mounted to bulkheads or the arm of a seat. The display device 130 can also be a portable or wireless electronic device or personal electronic device (PED), such as a computer, smartphone, tablet, etc., operable to communicate with the airside server 120. Such communications can be available via a wireless access point (WAP) in communication with the airside server 120.

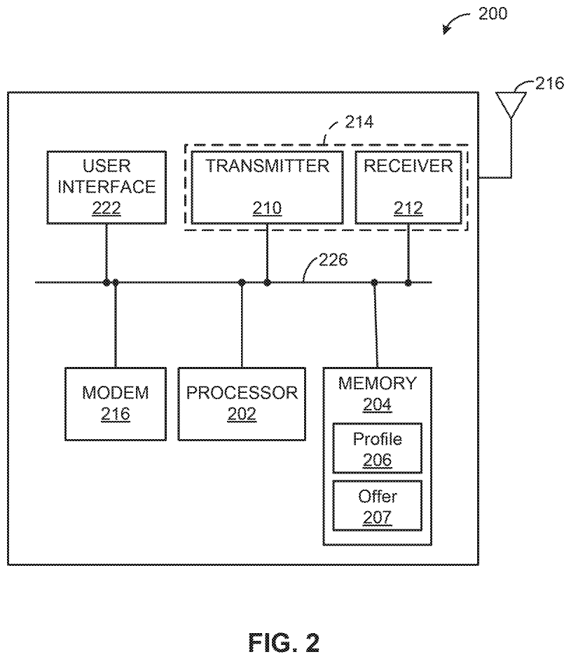

The display device 130 can have, for example, a processor, a memory, and a user interface that allows a user to interact with the IFE system 110 to retrieve and consume media during flight (see below description of FIG. 2). The airside server 120 and the plurality of display devices 130 can be combined within an inflight entertainment (IFE) system 110 within the airplane 112. The airside server 120 can be coupled to the plurality of display devices 130 via a network 114. The network 114 can have both wired network infrastructure and wireless networking capabilities. In some implementations, such a network is a wired network 114 coupling the airside server to the display devices 130 hard-mounted within the airplane 112. In other implementations, the network 114 can include WAPs to create a wireless network 114 for communication with PEDs carried aboard by passengers. In yet other implementations, the network 114 includes both a wired portion coupling the airside server to display devices 130 mounted within the aircraft and a wireless portion having WAPs providing communication for PEDs with the airside server. The wireless network 114 may be divided into private and public segments, in which the private segment is only for use by crew and the public segment is for use by non-crew passengers. The IFE system 112 can provide a source of entertainment to each passenger in the airplane 110, providing a variety of media content (TV, movies, music, books, etc.) and services (Internet connectivity, social media, email, etc.) to the viewing/operating passenger.

The system 100 can have a groundside server 140 communicatively coupled to the airside server 120 and the IFE system 110. The groundside server 140 can have one or more processors and associated memories (see below description of FIG. 2) adapted or operable to perform various tasks as disclosed herein. The processors of the groundside server 140 can be localized or distributed and take advantage of various distributed processing protocols or so-called cloud computing. The groundside server 140 can be owned and/or operated by the air carrier or by another company providing media services to the air carrier and the airplane 112, for example. The air carrier can be a private or commercial aviation company that transports passengers. Commercial air carriers (e.g., airlines) are used as a primary example herein, however that is not limiting on the disclosure. In particular, the systems and methods of this disclosure are not limited to use in commercial aviation platforms and can be implemented on other commercial or public transportation platforms or vehicles such as buses, trains, etc.

The groundside server 140 can be communicatively coupled to a third party server 150. The groundside server 140 and the third party server 150 can be coupled by a network 142, such as the Internet. The third party server 150 can be maintained by a third party company. The third party company can be a vendor, manufacturer, or retail company that produces, markets, and/or sells products and/or services, for example.

The groundside server 140 can receive certain offers from the third party server 150 related to their respective products and services. The offers can relate to various rewards such as coupons, subscription offers, discounts, certificates, free products, just to name a few options. In some implementations, the offers received from the third party server 150 can include rewards for the completion of certain tasks.

The groundside server 140 can receive and store the offers or rewards from the third party server 150 and save them to a database (e.g., a memory; see below description of FIG. 2) as digital assets. The groundside server 140 can store such digital assets (received from the third party server 150) including descriptions of rewards, reward settings, and rewards inventory, for example. The groundside server 140 can organize or catalog the offers/rewards, configure display rules (for presentation via the display devices 130), configure specific advertising targets, and create “rewards loadable” files for transmission to the IFE system 110, as needed. The rewards loadable files can include the rewards and the associated tasks users are required to complete in order to receive the rewards. The advertising targets can include specific air routes, airlines, geographic zones, or specific locations. In some embodiments, the company or companies associated with the rewards may specify such targets or desired markets. In some embodiments, the rewards and associated tasks required to receive the rewards can be paired or otherwise aggregated at the groundside server 140. In still other embodiments, the third party and the airline can share in the control over the aggregation of offers, tasks, and advertising targets.

The groundside server 140 can communicate with the airside server 120 via one or more wireless communication protocols. For example, the groundside server 140 can communicate with the airside server 120 via various radiofrequency (RF) communication systems, including satellite communications or direct, point-to-point RF signals. The groundside server 140 can further transmit the rewards loadable information to the airside server 120. The airside server 120 can then distribute or otherwise present the rewards via the display devices 130, as appropriate. The groundside server 140 can also receive from the airside server 120 a rewards log, including information about rewards redeemed, rewards ignored, task completion statistics, the type of rewards offered, the number of times a reward has displayed, among other information.

In some implementations, the groundside server 140 can provide the rewards/offers (e.g., the rewards loadable files) to the IFE system 110 and thus to the airside server 120 based on specific criteria related to content viewed on the display device 130. For example, such criteria can be based on the type of media being consumed at the display device 130. The number and type of specific reward offers displayed can also be based on certain information contained in a user profile of the user. The groundside server 140 can further package rewards received from the third party server 150 according to specific flight information and provide the packaged rewards (e.g., as the reward loadable) as appropriate.

In some other implementations, the airside server 120 can transmit a request to the groundside server 140 to provide offers based on various conditions within the airplane 110. For example, the airside server 120 can request specific offers to present to a specific individual or operator at one of the plurality of the display devices 130. In such an example, the offers presented can be based on certain demographic information known about a passenger, a profile (FIG. 2) of the user, duration of flight, specific geographic location during the flight, a point in time during a given flight, completion of tasks or other criteria, takeoff and landing locations, etc.

In implementations, the airside server 120 can store rewards configuration rules and content, distribute the rewards to the display devices 130 according to the rules and content displayed or consumed by the passenger, and collect reward logs based on the rewards offered and redeemed. The airside server 120 can then provide the rewards logs to the groundside server 140 for storage and analysis.

The groundside server 140 and the airside server 120 either alone or in combination can further perform various processes on the rewards information and data provided by the third party server 150 in association with various user data to provide offers (and reward opportunities) to users at optimum times. Certain artificial intelligence (AI) processes can also be implemented to learn (e.g., via machine learning (ML)) an thereafter predict what type of offers will be accepted and pursued by given users. In some examples, information about individual users can be stored to user profiles (FIG. 2) and can then be users to predict what offers will be accepted during specific periods of flight. For example, this can include travel types (e.g., business or leisure), ticket class (e.g., first class, business, economy). In addition, the user profile 206 can further include or be tied to frequent flyer status to determine types of rewards and offers provided to a given user/passenger.

FIG. 2 is a functional block diagram of a device for performing the functions of the method of FIG. 1. A device 200 can be implemented to perform the functions of the airside server 120, the display device 130, the ground side server 140, and/or the third party server 150, as needed.

The device 200 can include one or more processor units (processor) 202. The processor 202 can control operation of the device 200. Processor 202 can perform all the functions required to allow the system 100 provide offers and rewards to users in the airplane 112, for example. The processor 202 can also be referred to as a central processing unit (CPU).

The processor 202 can include or be a component of a processing system implemented with one or more processors 202. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processor 202 can further include distributed processors for distributed- or cloud computing.

The system 200 can also have a memory 204 coupled to the processor 202. The memory 204 can include both read-only memory (ROM) and random access memory (RAM). The memory 204 can include internal memory, external memory (e.g., one or more remote databases), and removable memory (e.g., removable media), for example. The memory 204 can provide instructions and data to the processor 202. At least a portion of the memory 204 can also include non-volatile random access memory (NVRAM). The processor 202 can perform logical and arithmetic operations based on program instructions stored within the memory 204. The instructions in the memory 204 can be executable to implement the behaviors of the AI processors and ML capabilities to optimize and improve the efficiency of content delivery (e.g., media, offers, rewards, etc.) to users via the display devices 130.

The processing system and the memory 204 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors (e.g., the processor 202), cause the processing system to perform the various functions described herein.

In some implementations, the memory 204 can further include one or more databases for storing one or more user profiles 206, a plurality of offers 207 (e.g., from the third party server 150), and data associated with various characteristics related to individual users (based on the profiles), route of flight, time of flight, and/or destination/location, for example. The memory 204 can store and use data related to passengers or users of the IFE system 100, in addition to data and information related to offers provided by the third party server 150 and the related rewards. The memory 204 can further implement distributed memory systems or a distributed ledger, such as that associated with block chain. The block chain can be used to authenticate certain transactions such as rewards provided for redemption. Such a ledger can include, for example, information relating to the user (e.g., the profile 206), identification of the reward and associated completion criteria, flight information (flight number, takeoff, landing, destination, etc.). Other information authenticating the reward and its delivery to a user can be included in the ledger.

The user profiles 206 can be created by the user via the display device 130 in the airplane 110, or via other interactive means, such as a website on a computer or wireless electronic device (e.g., a tablet, smartphone, etc.). The profiles 206 can also be created based, for example, on other criteria such as the purchase of an airline flight (or other interactions with the air carrier or related service provider) and/or a frequent flier program (or similar rewards program). The profiles 206 can include demographic information about the user(s) and various preferences of the user(s). The profiles 206 can further be updated to reflect interactions with the IFE system 110, including, for example, purchases made, consumed content, travel habits, travel origins/destinations, user in-flight entertainment usage behavior, among other things. These data can be manually input by the user. These data can be further recorded or otherwise saved by the processor 202 as events occur and processed in a ML or AI context.

In some implementations the memory 204 and profiles 206 can be used in certain predictive analytics to determine what offers 207 to present to a given user. The offers 207 can be received from the third party server 150 at both the ground side server 140 and the airside server 120 (e.g., via the groundside server 140). The processor 202 can then determine, based on the profiles 206, flight characteristics, and other aspects, what offers to present and when.

The device 200 can also include a transmitter 210 and/or a receiver 212 to allow transmission and reception of data between the system 200 and a remote location. For example, the groundside server 140 can communicate wirelessly with the airside server 130 (e.g., the IFT system 110) via one or more wireless channels or protocols. In some implementations, the third party server 150 can also communicate with the groundside server 140 via wireless means.

The transmitter 210 and the receiver 212 can be combined into a transceiver 210. The system 200 can also include (not shown) multiple transmitters, multiple receivers, multiple transceivers, and/or multiple antennas or antenna arrays as needed for various communication standards via wireless or wireline communications.

The system 200 can further have a modem 216 coupled to the transmitter 210, the receiver 212, or the transceiver 214. The modem 216 can perform modulation demodulation tasks for communication with an external network, for example. In some implementations the processor 202 can communicate via the transmitter 210, the receiver 212, and/or the transceiver 214 via the Internet, as needed. In some embodiments, the transmitter 210 and the receiver 212 can be configured to transmit and receive information via other wired or wireline systems or means.

The system 200 can have a user interface 222. The user interface 222 can include one or more controls allowing user interaction with the device 200. For example user interface 222 can include one or more buttons, keys, pointing device, speakers, and/or microphones to provide means for interaction with the device 200. The user interface 222 can also include interaction means for the display device 130 implemented as, for example, a seatback monitor or a wireless mobile device (e.g., the display device 130) operated by a user/passenger. A user can interact with the user interface 222 to select, for example, desired media content or offers in order to receive rewards.

The various components of the device 200 can be coupled together with a communications bus 226. The communications bus 226 can provide intercommunication between the components of the device, in addition to connectivity to a network or the Internet, for example.

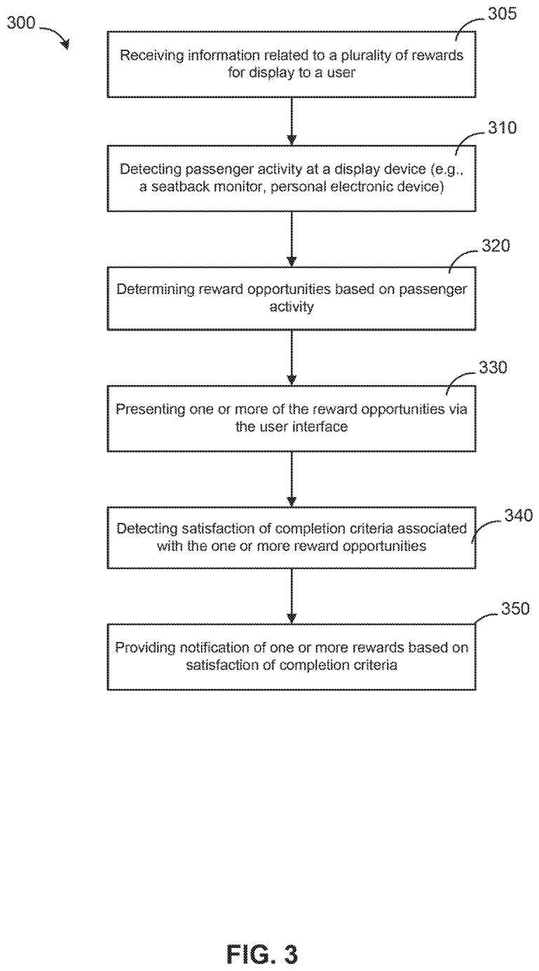

FIG. 3 is a flowchart of an embodiment of a method for providing in-flight rewards associated with the system of FIG. 1 and the device of FIG. 2. A method 300 can be performed by the airside server 120, the groundside server 140, and the display device 130, either alone or in cooperation using the device 200.

The method 300 can begin at block 305. At block 305, the groundside server 140 can receive information (e.g., reward information) related to a plurality of rewards. The information can be received from the third party server 150. The rewards can include certain benefits or rewards available to a user (e.g., a passenger) realized upon or based upon completion of a task. Some exemplary rewards can include coupons, subscription offers, discounts, (gift) certificates, and free products, for example. Other rewards are possible. Subscription offers may include an offer of inflight Internet connectivity for a limited period of time. The groundside server 140 can further upload the rewards, offers associated with the rewards, and accompanying data to the airside server 130 for distribution to by the airside server 130 to the display devices 130.

The rewards can be coupled to a specific task. For example, the reward information can tie specific rewards to individual tasks, identified by a particular vendor. In such an example, a department store can offer a given coupon or discount if they watch a specified ad or complete a survey about a particular product using the IFE system 110. The department store operator can thus specify which task is associated with which reward.

In other embodiments, the groundside server 140 can receive the reward information from the third party server 150 and package the rewards (e.g., as offers) according to the user profiles 206 or other user or flight information, for example. For example, the carrier operator can use flight information to advertise specific restaurant or hotel rewards for a given flight destination and offer associated rewards based on watching an advertisement provided by the IFE system 110 at a certain time during flight. In other examples, the carrier operator can provide reward offers based on takeoff and landing times, such as offering free beverages during flight based on the completion of a survey or watching a particular movie, using the IFE system 100. The groundside server 140 can package such rewards as offers and then provide the offers based user profiles, flight details, and user interaction with the IFE system 100. Flight details can include, for example, takeoff and landing destinations, takeoff and landing times, route of flight, air carrier or airline, among other details.

In another example, the groundside server 140 can also offer discounts for onboard shopping (e.g., aboard the airplane 112) based on live inventory data on the aircraft (e.g., the airplane 112). Aircraft can send onboard shopping merchandise inventory data to the groundside server 140. If the groundside server 140 determines onboard inventory is too high, the groundside server 140 can include, for example, an “onboard shopping voucher” as one of the rewards to incentivize people to buy more while onboard the airplane 112 or in flight.

At block 310, the processor 202 can detect user activity or user interaction (e.g., a passenger interaction) with the display device 130 (e.g., via the user interface 222). The IFE system 110 can detect a passenger using an IFE system function (e.g., user activity, such as watching a movie, playing a game, taking a survey, etc.) on the display device 130 (e.g., the seatback monitor or PED).

The processor 202 can prompt, via the display device 130, the user to create a user profile (e.g., the user profile 206). The user can input certain personal information and preferences that the IFE system 110 can use to present rewards that are more likely to interest the user, or that the user is more likely to redeem. If the user already has an appropriate profile, he or she may log into the IFE system 110 using existing credentials.

The processor 202 (e.g., the airside server 130) can then detect a type of passenger activity. The processor 202 can determine if the passenger usage/activity qualifies for reward opportunity. Such determination for a reward opportunity can be based on a predefined selection of function usage rate, importance of the function, onboard retail inventory, passenger demographics, passenger seat selection, and flight profile, for example. In some examples, importance of the application can include a survey deemed to have an elevated importance to the airline. The groundside server 140 can package a reward for completion of that survey by a passenger.

In some embodiments of the method 300, the display device 130 may display advertisements or offers, independent of user interaction. Thus, the step of block 210 may be optional.

At block 320, the processor 202 can determine that a passenger (e.g., one or more passengers) has qualified for a reward opportunity. The processor 202 can then determine which type of reward to present. The system can dynamically choose the reward base on factors such as type and frequency of passenger activity, passenger demographic, flight profile, flight destination, time remaining in the flight, among other options.

At block 330, the processor 202 can display the reward and the conditions of the reward, based on the block 320. The reward and tasks or conditions associated with the reward can be based on the pairing completed either at the third party server 150 or by the groundside server 140.

At block 340, the processor can detect that the user has completed one or more tasks associated with the reward offer (of block 330). In some implementations, the airside server 120 can record that a user has completed tasks to receive the associate award. The airside server 120 can log this in the profile 206 of a user. In some implementations, block chain can be implemented to record the completion of tasks and the issuance of rewards.

At block 350, the processor can provide an indication that the reward has been earned (based on the detecting at block 340). The processor 202 can display the indication via the display device 130 and the reward can then be fulfilled. For example, when a use claims their reward upon satisfying the completion criteria, a “claim record” is made. The claim record can be recorded by the aircraft IFE system 110 (e.g., headend or the airside server 120). The claim record can then be communicated from the IFE system 110 to the groundside server 140. This can be recorded as a system log using, for example, a block chain distributed ledger. An email notification can also be sent to the user with appropriate links to the reward or reward information. Emails or other electronic notification can further be send to the retail company at which the reward is redeemable. The groundside server 140 can store a log of claim records to brands or advertisers associated with the third party server 150. In some implementations, periodic payment for goods and services can be based number of claims and fee per contract for providing the rewards. The block chain ledger can then be used to verify the authenticity of rewards.

Rewards fulfillment can be performed in a number of ways. In an implementation, the reward can be a physical good such as a gift certificate, a can of soda, or bag of chips. In such an example, the flight crew can be notified (via the IFE system 110) of a reward redemption, at which point the flight crew can physically deliver the reward to the appropriate passenger.

In another implementation, the reward can be provided in a digital format. The digital award can be, for example, a coupon, gift certificate, or other digitally delivered reward. In one example, the passenger can create a digital wallet, for example, in the memory 204. The digital wallet can be associated with the user profile 206 and contain all a given passenger's rewards. The passenger can then access the digital wallet via an Internet portal (e.g., a web page) at any time and select which reward to use or redeem.

In another example, the user or passenger can provide contact information, such as email or phone number. This contact information may or may not be associated with the profiles 206. The processor 202 (e.g., the groundside server 140) can transmit the digital reward to the passenger in an electronic manner, via email or text message, for example. All records related to offers, rewards, completion criteria, and the users/passengers that redeem the rewards can be recorded in a server (e.g., the memory 204) and can be accessed via an Internet or web portal. All records can be similarly saved using a distributed ledger system such as block chain.

### Other Aspects

The accompanying claims and their equivalents are intended to cover such forms or modifications as would fall within the scope of the disclosure. For instance, the example apparatuses, methods, and systems disclosed herein may be applied to in-flight entertainment systems or other rewards programs associated with travel. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure. Accordingly, the different embodiments and implementations disclosed herein can be freely combined as needed.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical or functional blocks and algorithm operations and method steps described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative functional blocks, method steps, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects.

Thus, the claims are not intended to be limited to the aspects shown herein, but is to be accorded the full scope consistent with the language claims, wherein reference to an element in the singular is not intended to mean “one and only one” unless specifically so stated, but rather “one or more.”

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for providing in-flight rewards comprising:
receiving, at one or more processors, information related to a plurality of rewards for redemption by a user, each reward of the plurality of rewards being associated with completion criteria, the completion criteria including one or more actions required to redeem each reward;
combining, at the one or more processors, the completion criteria with one or more rewards of the plurality of rewards as offers;
detecting user activity at a display device;
presenting, by the one or more processors, one or more offers of a plurality of offers via the display device based on the user activity and one or more flight details;
detecting, at the one or more processors, satisfaction of the completion criteria; and
presenting the one or more rewards via the display device based on the detecting.

2. The method of claim 1 further comprising delivering the one or more rewards to an online account of the user, wherein the one or more rewards comprises at least one of a coupon, a discount, and a gift certificate.

3. The method of claim 1 further comprising storing a user profile for the user, the user profile including reward redemption history, personal information, and personal preferences of the user.

4. The method of claim 3 further comprising storing a distributed rewards ledger in memory, including the reward, the completion criteria, and an identification of the user.

5. The method of claim 3 wherein the presenting is further based on the user profile.

6. The method of claim 1, wherein the completion criteria includes one of consuming a specified type of media and completing a survey.

7. The method of claim 1, wherein the reward is transmitted in a message to an electronic account of the user, wherein the message comprises one of an email, a text message, and a voucher stored in an electronic wallet.

8. The method of claim 1, wherein the one or more flight details include one or more of a takeoff and landing time, a takeoff and landing destination, duration of flight, and a time during flight.

9. The method of claim 1, wherein the display device comprises a personal electronic device or a seatback monitor.

10. A system for providing in-flight rewards comprising:
a memory configured to store information related to a plurality of rewards for redemption by a user, each reward of the plurality of rewards being associated with completion criteria, the completion criteria including one or more actions required to redeem each reward; and
one or more processors configured to
combine the completion criteria with one or more rewards of the plurality of rewards as offers,
detect user activity at a display device,
present one or more offers of a plurality of offers via the display device based on the user activity and one or more flight details,
detect satisfaction of the completion criteria, and
present the one or more rewards via the display device based on the detecting.

11. The system of claim 10 wherein the one or more processors is further configured to deliver the one or more rewards to an online account of the user, wherein the one or more rewards comprises at least one of a coupon, a discount, and a gift certificate.

12. The system of claim 10, wherein the one or more processors is further configured to store a user profile for the user, the user profile including reward redemption history, personal information, and personal preferences of the user.

13. The system of claim 12, wherein the presenting is further based on the user profile.

14. The system of claim 10, wherein the completion criteria includes at least one of consuming a specified type of media and completing a survey.

15. The system of claim 10, wherein the reward is transmitted in a message to an electronic account of the user, and wherein the message comprises one of an email, a text message, and a voucher stored in an electronic wallet.

16. The system of claim 10, wherein the one or more flight details include one or more of a takeoff and landing time, a takeoff and landing destination, duration of flight, and a time during flight.

17. The system of claim 10, wherein the display device comprises a personal electronic device or a seatback monitor.

18. A non-transitory computer-readable medium storing instructions for providing in-flight rewards, that when executed by one or more processors, cause the one or more processors to:
receive information related to a plurality of rewards for redemption by a user, each reward of the plurality of rewards being associated with completion criteria, the completion criteria including one or more actions required to redeem each reward;
combine the completion criteria with one or more rewards of the plurality of rewards as offers;
detect user activity at a display device;
present one or more offers of a plurality of offers via the display device based on the user activity and one or more flight details;
detect satisfaction of the completion criteria; and
present the one or more rewards via the display device based on the detecting.

19. The non-transitory computer-readable medium of claim 18, wherein the instructions further cause the one or more processors to deliver the one or more rewards to an online account of the user, wherein the one or more rewards comprises at least one of a coupon, a discount, and a gift certificate.

20. The non-transitory computer-readable medium of claim 18, wherein the instructions further cause the one or more processors to store a user profile for the user, the user profile including reward redemption history, personal information, and personal preferences of the user.
